(19) United States
(12) Patent Application Publication
(10) Pub. No.: US 2014/0001169 A1
(43) Pub. Date: Jan. 2, 2014

(54) TWO-WAY COMMUNICATION BETWEEN A WIRE FEEDER AND A WELDING POWER SOURCE PROVIDING IMPROVED OPERATION

(71) Applicants: Edward A. Enyedy, Eastlake, OH (US); William Delvon Wilder, Cleveland, OH (US); William T. Matthews, Chesterland, OH (US); Bruce John Chantry, Solon, OH (US)

(72) Inventors: Edward A. Enyedy, Eastlake, OH (US); William Delvon Wilder, Cleveland, OH (US); William T. Matthews, Chesterland, OH (US); Bruce John Chantry, Solon, OH (US)

(73) Assignee: LINCOLN GLOBAL, INC., City of Industry, CA (US)

(21) Appl. No.: 13/535,572

(22) Filed: Jun. 28, 2012

(51) Int. Cl. B23K 9/10

(52) U.S. Cl. 219/137.71

(57) ABSTRACT

Systems and methods of communicating between a welding power source and a welding wire feeder to improve the operation of a welding system. Two-way communication between a welding power source and a welding wire feeder is provided either wirelessly or over the welding output cable. The communication between the welding power source and the welding wire feeder facilitates output voltage selection at the welding wire feeder as well as the entering of a lower output power state of the welding power source when not welding.

### TECHNICAL FIELD

Certain embodiments of the present invention relate to welding. More particularly, certain embodiments of the present invention relate to systems and methods of communicating between a welding power source and a welding wire feeder to improve the operation of a welding system.

### BACKGROUND

In many prior art welding systems, the output voltage level of the welding power source switches between a higher open circuit voltage level (when not welding) and a lower welding output voltage level (when welding). The constant presence of such a higher open circuit voltage level when not welding can present a hazard to the operator or to the workpiece to be welded. Furthermore, welding wire feeders also often have electrical contactors which switch high power provided by a welding power source to a welding electrode. Contactors add cost and weight to the welding wire feeder and require frequent maintenance. Many prior art welding systems use welding wire feeders that rely on batteries or other energy storage devices in the welding wire feeder to provide electrical power for operation of the welding wire feeder. Such batteries or other energy storage devices are an added expense to the welding wire feeder and can be drained rather quickly, depending on the operation of the welding wire feeder. Also, many prior art welding systems rely on a dedicated control cable between the welding power source and the welding wire feeder which adds weight, can cause trip hazards, and frequently requires repair.

Further limitations and disadvantages of conventional, traditional, and proposed approaches will become apparent to one of skill in the art, through comparison of such systems and methods with embodiments of the present invention as set forth in the remainder of the present application with reference to the drawings.

### SUMMARY

Embodiments of the present invention provide systems and methods of communicating between a welding power source and a welding wire feeder to improve the operation of a welding system. Two-way communication between a welding power source and a welding wire feeder is provided either wirelessly or over the welding output cable. The communication between the welding power source and the welding wire feeder facilitates output voltage selection at the welding wire feeder as well as the entering of a lower output power state of the welding power source when not welding.

One embodiment of the present invention is a method of communication between a welding power source and a welding wire feeder. The method includes communicating a welding power source identifier, corresponding to a welding power source type, from a welding power source being of the welding power source type to a welding wire feeder operatively connected to the welding power source. The method also includes automatically scaling an output range of an output control device of the welding wire feeder, in response to the welding power source identifier, to a range of welding output voltage values corresponding to a range of welding output potentials provided by the welding power source. The method may further include automatically displaying a welding output voltage value on a display of the welding wire feeder corresponding to a present setting of the output control device. The method may also include communicating a present setting of the output control device from the welding wire feeder to the welding power source. The communicating may be performed wirelessly or via encoded signals over a welding output cable operatively connecting the welding power source to the welding wire feeder. The method may further include the welding power source providing a welding output potential, corresponding to the welding output voltage value, to the welding wire feeder over a welding output cable operatively connecting the welding power source to the welding wire feeder.

One embodiment of the present invention is a method of communication between a welding power source and a welding wire feeder. The method includes communicating a welding power source identifier, corresponding to a welding power source type, from a welding power source being of the welding power source type to a welding wire feeder operatively connected to the welding power source. The method also includes communicating a present setting value from the welding wire feeder to the welding power source, wherein the present setting value is based on a present setting of an output control device of the welding wire feeder and the welding power source identifier. The method may further include the welding power source automatically converting the present setting value to a welding output voltage value, and communicating the welding output voltage value from the welding power source to the welding wire feeder. The communicating may be performed wirelessly or via encoded signals over a welding output cable operatively connecting the welding power source to the welding wire feeder. The method may also include displaying the welding output voltage value on a display of the welding wire feeder. The method may further include the welding power source providing a welding output potential, corresponding to the welding output voltage value, to the welding wire feeder over a welding output cable operatively connecting the welding power source to the welding wire feeder.

One embodiment of the present invention is a method of controlling an electrical output of a welding power source. The method includes regulating an electrical output of a welding power source to a low output voltage level of a low power state of the welding power source. The method also includes regulating the electrical output of the welding power source to an open circuit voltage level when a trigger signal is received at the welding power source from a welding wire feeder, wherein a magnitude of the open circuit voltage level is larger than a magnitude of the low output voltage level. The method further includes regulating the electrical output of the welding power source to a welding output voltage level when an electric arc exists between an electrode and a workpiece electrically connected to the electrical output of the welding power source, wherein a magnitude of the welding output voltage level is between the magnitudes of the low output voltage level and the open circuit voltage level. The method may also include regulating the electrical output of the welding power source to the low output voltage level of the low power state of the welding power source when the trigger signal is no longer received by the welding power source. The trigger signal may be wirelessly received by the welding power source from a welding wire feeder, or may be received by the welding power source over a welding output cable operatively connected between the welding power source and a welding wire feeder.

One embodiment of the present invention is a welding system. The welding system includes a welding power source having a first wireless transceiver. The system also includes a welding wire feeder having a second wireless transceiver, wherein the first wireless transceiver and the second wireless transceiver are configured to provide two-way communication between the welding power source and the welding wire feeder. The system further includes a welding output cable operatively connecting the welding power source to the welding wire feeder for providing electrical power from the welding power source to the welding wire feeder, wherein the second wireless transceiver is configured to be powered by electrical power from the welding power source. The system may further include a plurality of calibration curves stored in a computer memory of the welding wire feeder. Each calibration curve of the plurality of calibration curves corresponds to a welding power source type and is configured to scale an output range of an output control device of the welding wire feeder to a range of welding output voltage values in response to the second wireless transceiver receiving a welding power source identifier, corresponding to a welding power source type, from the first wireless transceiver. The range of welding output voltage values may correspond to a range of welding output potentials that a welding power source of the corresponding welding power source type is configured to provide to the welding wire feeder over the welding output cable. In accordance with an embodiment, the welding wire feeder may be configured to be fully powered by electrical power from the welding power source.

One embodiment of the present invention is a welding system. The welding system includes a welding power source having a first transceiver, a welding wire feeder having a second transceiver, and a welding output cable operatively connecting the welding power source to the welding wire feeder for providing electrical power from the welding power source to the welding wire feeder. The second transceiver is configured to be powered by electrical power from the welding power source. The first transceiver and the second transceiver are configured to provide two-way communication between the welding power source and the welding wire feeder over the welding output cable. The system may further include a plurality of calibration curves stored in a computer memory of the welding wire feeder. Each calibration curve of the plurality of calibration curves corresponds to a welding power source type and is configured to scale an output range of an output control device of the welding wire feeder to a range of welding output voltage values in response to the second wireless transceiver receiving a welding power source identifier, corresponding to a welding power source type, from the first wireless transceiver. The range of welding output voltage values may correspond to a range of welding output potentials that a welding power source of the corresponding welding power source type is configured to provide to the welding wire feeder over the welding output cable. In accordance with an embodiment, the welding wire feeder may be configured to be fully powered by electrical power from the welding power source.

One embodiment of the present invention is a welding power source providing a low power state. The welding power source includes a transceiver configured to facilitate two-way communication with a welding wire feeder. The transceiver may be a wireless transceiver, or the transceiver may be configured to communicate with a welding wire feeder over a welding output cable operatively connected between the welding power source and the welding wire feeder. The welding power source also includes electrical output circuitry providing an electrical output. The welding power source further includes a controller configured to control the electrical output circuitry. The controller controls the electrical output circuitry by regulating the electrical output to a low output voltage level of a low power state of the welding power source when a trigger signal is not being received by the transceiver. The controller also controls the electrical output circuitry by regulating the electrical output to an open circuit voltage level when a trigger signal from a welding wire feeder is being received by the transceiver, and when an electric arc does not exist between an electrode and a workpiece electrically connected to the electrical output circuitry. A magnitude of the open circuit voltage level is larger than a magnitude of the low output voltage level. The controller further controls the electrical output circuitry by regulating the electrical output to a welding output voltage level when a trigger signal from a welding wire feeder is being received by the transceiver, and when an electric arc exists between an electrode and a workpiece electrically connected to the electrical output circuitry. A magnitude of the welding output voltage level is between the magnitudes of the low output voltage level and the open circuit voltage level. In accordance with an embodiment, the low power state of the welding power source is configured to provide electrical power to fully power a welding wire feeder operatively connected to the welding power source.

Details of illustrated embodiments of the present invention will be more fully understood from the following description and drawings.

### BRIEF DESCRIPTION OF THE DRAWINGS

FIG. 1 illustrates a schematic block diagram of an exemplary embodiment of a welding system having a welding power source and a welding wire feeder;

FIG. 2 is a functional block diagram illustrating a first exemplary embodiment of communication between the welding power source and the welding wire feeder of FIG. 1;

FIG. 3 illustrates a schematic block diagram of a first exemplary embodiment of the welding power source and the welding wire feeder of FIG. 1 and FIG. 2;

FIG. 4 illustrates a schematic block diagram of a second exemplary embodiment of the welding power source and the welding wire feeder of FIG. 1 and FIG. 2;

FIG. 5 is a flowchart of a first exemplary embodiment of a method of communication between the welding power source and the welding wire feeder of FIG. 1;

FIG. 6 is a graph illustrating exemplary embodiments of two calibration curves of two welding power sources being of two different welding power source types;

FIG. 7 is a flowchart of a second exemplary embodiment of a method of communication between the welding power source and the welding wire feeder of FIG. 1;

FIG. 8 is a functional block diagram illustrating a second exemplary embodiment of communication between the welding power source and the welding wire feeder of FIG. 1;

FIG. 9 illustrates a schematic block diagram of an exemplary embodiment of the welding power source of FIG. 8; and

FIG. 10 is an exemplary embodiment of a timing diagram illustrating the operation of the welding power source of FIG. 9.

### DETAILED DESCRIPTION

The following are definitions of exemplary terms that may be used within the disclosure. Both singular and plural forms of all terms fall within each meaning:

“Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Computer” or “processing element” or “computer device” as used herein includes, but is not limited to, any programmed or programmable electronic device that can store, retrieve, and process data. “Non-transitory computer-readable media” include, but are not limited to, a CD-ROM, a removable flash memory card, a hard disk drive, a magnetic tape, and a floppy disk.

“Consumable welding package”, as used herein, refers to, but is not limited to, a drum of consumable welding wire, a box of consumable welding wire, a spool of consumable welding wire, a palette of consumable welding wire, or equivalents thereof.

“Welding tool”, as used herein, refers to, but is not limited to, a welding gun, a welding torch, or any welding device that accepts a consumable welding wire for the purpose of applying electrical power to the consumable welding wire provided by a welding power source.

“Welding power source identifier”, as used herein, refers to a code, a signal, information, or data indicating the type of a welding power source, and is used to allow a welding output voltage range of the welding power source to be known to a wire feeder.

“Output control device”, as used herein, refers to a device in a welding wire feeder allowing an operator to select a desired welding output potential to be provided by a welding power source. The output control device may include, but is not limited to, a potentiometer and an encoder.

“Welding output potential”, as used herein, refers to an actual welding output voltage provided by a welding power source.

“Present setting”, as used herein, refers to the output state of an output control device of a welding wire feeder at a present time.

“Present setting value”, as used herein, refers to the value of the output state of an output control device of a welding wire feeder at a present time.

“Welding output cable”, as used herein, refers to the electrical cable that may be connected between a welding power source and a welding wire feeder to provide electrical power from the welding power source to the welding wire feeder. The welding output cable may also be used for communication between the welding power source and the welding wire feeder.

“Encoded signals”, as used herein, refers to electrical signals having information encoded thereon.

“Electrical output”, as used herein, may refer to the electrical output circuitry or output port of a welding power source, or to the electrical power, voltage, or current provided by the electrical output circuitry or output port of a welding power source.

“Open circuit voltage”, as used herein, refers to the electrical potential provided by the electrical output of a welding power source when not welding and when not in a low power state.

“Trigger signal”, as used herein, refers to the signal, data, or information provided from a welding wire feeder to a welding power source indicating that a trigger of a welding tool has been activated.

“Wireless transceiver”, as used herein, refers to a transmitter and receiver configuration capable of providing two-way communication with another device via radio frequency means, infrared means, or other means not requiring a wired transmission path.

“Transceiver”, as used herein, refers to a transmitter and receiver configuration capable of providing two-way communication with another device via a wired transmission path.

“Computer memory”, as used herein, refers to a storage device configured to store digital data or information which can be retrieved by a computer or processing element.

“Calibration curve”, as used herein, refers to a mapping, conversion, or scaling from a range of input values to a range of output values. The terms “mapping”, “conversion”, and “scaling”, and derivative forms thereof, may be used interchangeably herein.

“Electrical output circuitry”, as used herein, refers to the circuitry within a welding power source directly associated with providing electrical output power for welding.

“Controller”, as used herein, refers to the logic circuitry and/or processing elements and associated software involved in controlling the electrical output of a welding power source in response to various input signals or data.

The terms “signal”, “data”, and “information” may be used interchangeably herein and may be in digital or analog form.

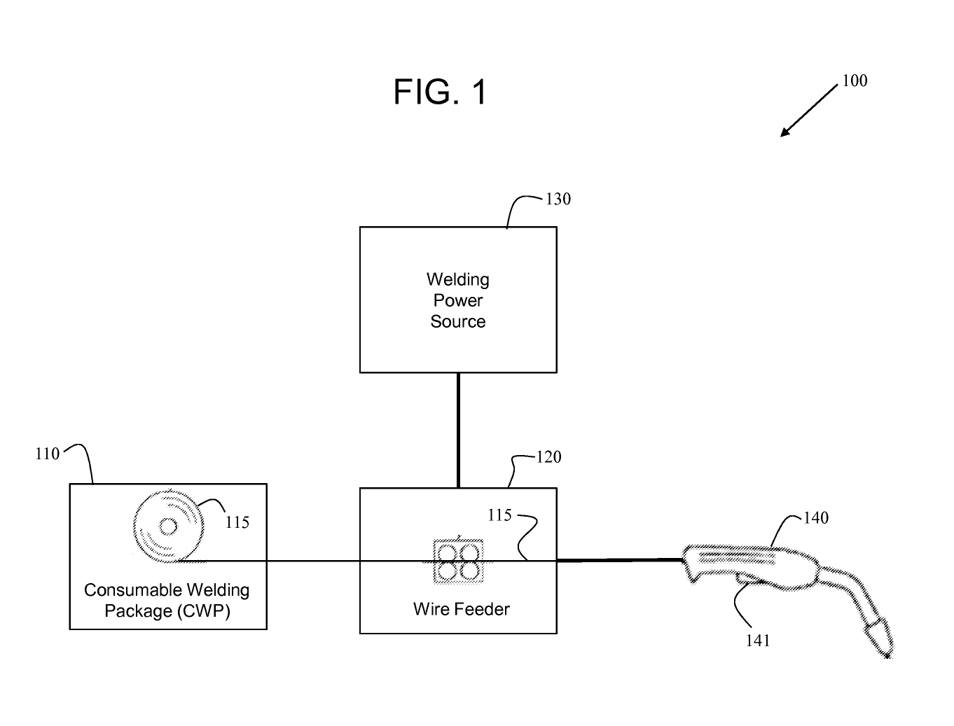

FIG. 1 illustrates a schematic block diagram of an exemplary embodiment of a welding system 100 having a welding power source 130 and a welding wire feeder 120. The system 100 also includes a welding tool 140 and a source of consumable welding wire 115 in the form of, for example, a consumable welding package 110. The welding power source 130 is operatively connected to the welding wire feeder 120, and the welding wire feeder is operatively connected to the welding tool 140. The wire feeder 120 feeds consumable welding wire 115 from the consumable welding package 110 to the welding tool 140. The welding power source 130 provides electrical power to the welding tool 140 via the welding wire feeder 120, which can be applied to the welding wire 115 at the welding tool 140, for example, for the purpose of welding a workpiece. In accordance with an embodiment of the present invention, the welding wire feeder 120 is configured to be fully powered by electrical power from said welding power source 130. No batteries are other energy storage devices are used by the wire feeder 120 as a source of electrical power.

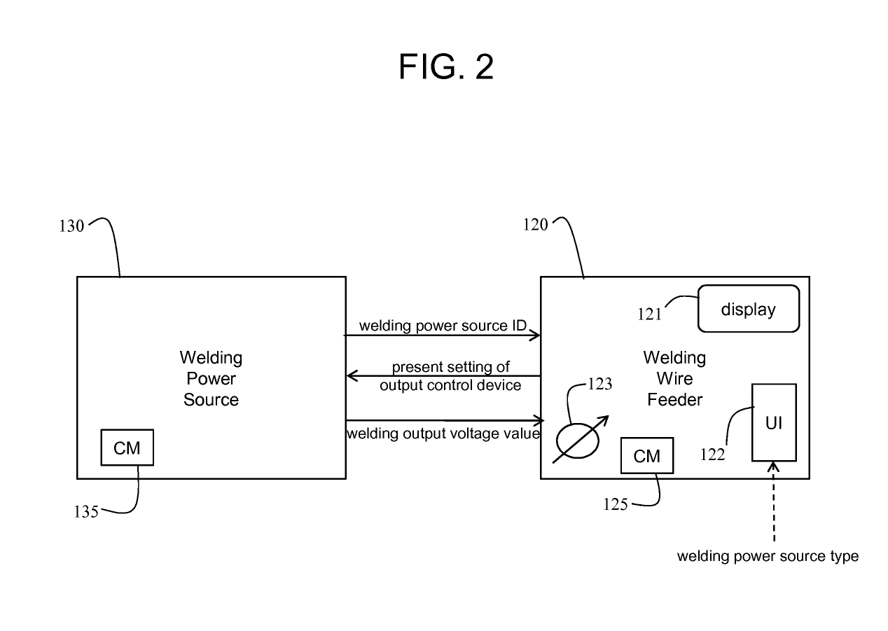

FIG. 2 is a functional block diagram illustrating a first exemplary embodiment of communication between the welding power source 130 and the welding wire feeder 120 of FIG. 1. The welding wire feeder 120 includes a display 121 (e.g., a liquid crystal display), a user interface 122 (e.g., a keypad or DIP switches), an output control device 123 (e.g., a dial or knob operatively connected to a potentiometer or to a encoder device), and computer memory 125. The output control device 123 is used by an operator to set or select the welding output voltage to be supplied by the welding power source 130 and applied to the welding wire 115 at the welding tool 140 via the welding wire feeder 120. In accordance with an embodiment, the display 121 may be used to present a selected welding output voltage to an operator.

Referring to FIG. 2, two-way communication takes place between the welding power source 130 and the welding wire feeder 120. For example, the welding power source 130 may communicate a welding power source identifier (ID) to the welding wire feeder 120. The welding power source ID identifies to the wire feeder 120 the type of welding power source 130 to which the wire feeder 120 is operatively connected. The wire feeder 120 may use the welding power source ID as described later herein. In accordance with an alternative embodiment of the present invention, the welding power source ID or type may be manually entered by an operator via the user interface 122.

Furthermore, the welding wire feeder 120 may communicate a present setting of the output control device (e.g., a voltage value from a potentiometer of the output control device, or an encoder value from an encoder of the output control device) to the welding power source 130. The welding power source 130 may use the present setting as described later herein. Also, the welding power source 130 may communicate a welding output voltage value to the welding wire feeder 120. The welding output voltage value may correspond to a present setting of the output control device 123, as described later herein, and may be displayed on the display 121 of the wire feeder 120.

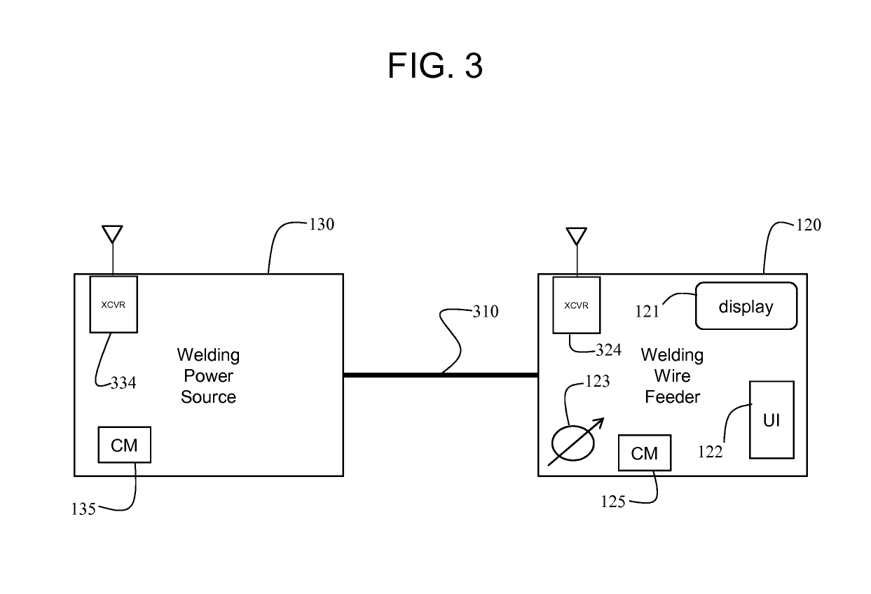

FIG. 3 illustrates a schematic block diagram of a first exemplary embodiment of the welding power source 130 and the welding wire feeder 120 of FIG. 1 and FIG. 2. The welding power source 130 includes a wireless transceiver 334 and the welding wire feeder includes a wireless transceiver 324. The transceivers 324 and 334 are each configured to transmit and receive information between the welding power source 130 and the welding wire feeder 120 wirelessly. For example, referring again to FIG. 2, the welding power source ID, the present setting of the output control device, and the welding output voltage value may be communicated via the wireless transceivers 324 and 334. The wireless transceivers 324 and 334 may be radio frequency (RF) transceivers, for example. Other types of wireless transceivers are possible as well such as, for example, infrared (IR) transceivers.

Electrical power is provided by the welding power source 130 to the welding wire feeder 120 via a welding output cable 310. However, the welding output cable 310 is not used for communication between the welding power source 130 and the wire feeder 120 in the embodiment of FIG. 3. In accordance with an embodiment of the present invention, the wireless transceiver 324 in the wire feeder 120 is powered by electrical power provided by the welding power source 130 over the cable 310. In accordance with another embodiment, the entire welding wire feeder 120 is configured to be fully powered by electrical power from the welding power source 130. Furthermore, electrical power provided by the welding power source 130 over the welding output cable 310 to the wire feeder 120 is also used to provide a welding output potential to the welding wire 115 at the welding tool 140 for welding.

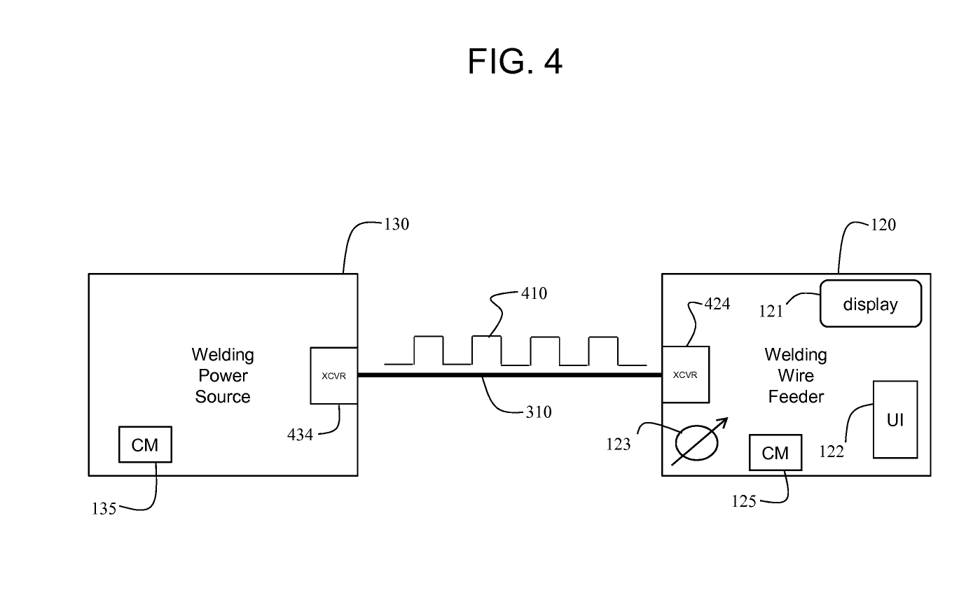

FIG. 4 illustrates a schematic block diagram of a second exemplary embodiment of the welding power source 130 and the welding wire feeder 120 of FIG. 1 and FIG. 2. The welding power source 130 includes a transceiver 434 and the welding wire feeder includes a transceiver 424. The transceivers 424 and 434 are each configured to transmit and receive information between the welding power source 130 and the welding wire feeder 120 over the welding output cable 310. For example, referring again to FIG. 2, the welding power source ID, the present setting of the output control device, and the welding output voltage value may each be communicated via the transceivers 424 and 434 as an electrical signal 410 over the welding output cable 310.

Again, electrical power is provided by the welding power source 130 to the welding wire feeder 120 via the welding output cable 310. However, the welding output cable 310 is also used for communication between the welding power source 130 and the wire feeder 120 in the embodiment of FIG. 4. In accordance with an embodiment of the present invention, the transceiver 424 in the wire feeder 120 is powered by electrical power provided by the welding power source 130 over the cable 310. In accordance with another embodiment, the entire welding wire feeder 120 is configured to be fully powered by electrical power from the welding power source 130. Furthermore, electrical power provided by the welding power source 130 over the welding output cable 310 to the wire feeder 120 is also used to provide a welding output potential to the welding wire 115 at the welding tool 140 for welding.

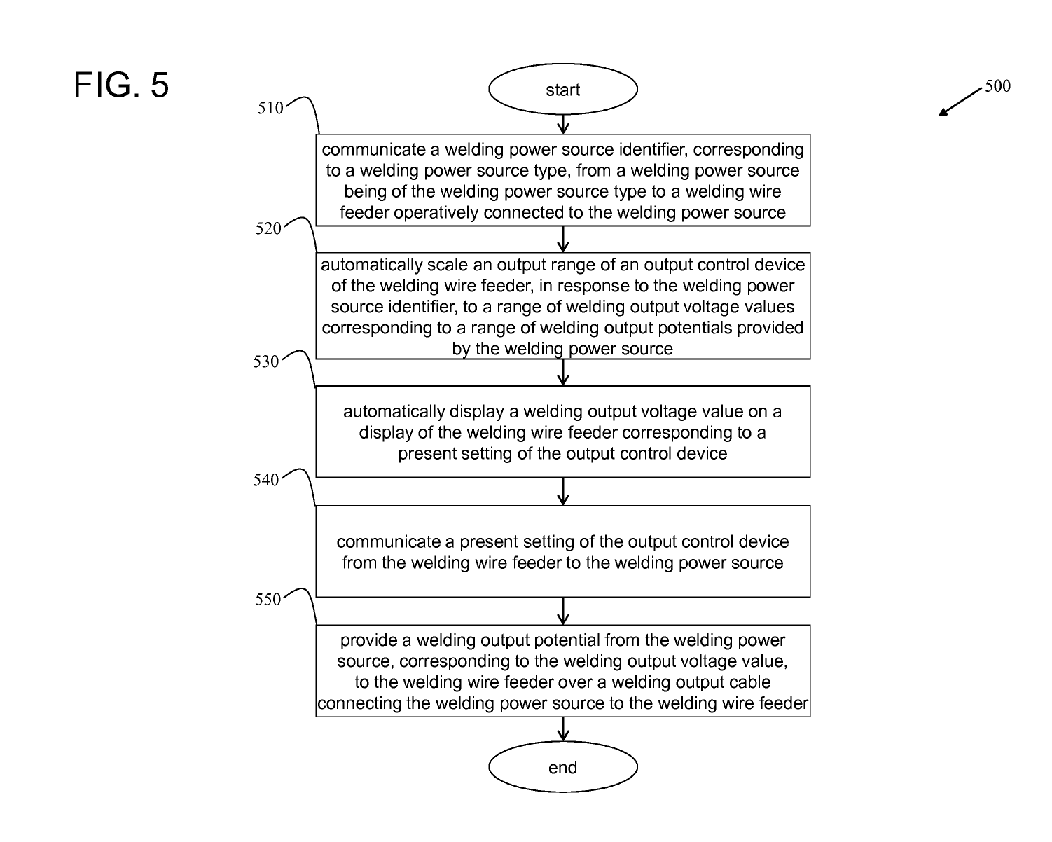

FIG. 5 is a flowchart of a first exemplary embodiment of a method 500 of communication between the welding power source 130 and the welding wire feeder 120 of FIG. 1. In step 510 of the method 500, a welding power source identifier (ID), corresponding to a welding power source type, is communicated from a welding power source, being of the welding power source type as identified by the ID, to a welding wire feeder operatively connected to the welding power source. In step 520 of the method 500, an output range of an output control device of the welding wire feeder is automatically scaled, in response to the welding power source ID, to a range of welding output voltage values corresponding to a range of welding output potentials provided by the welding power source.

In step 530 of the method 500, a welding output voltage value corresponding to a present setting of the output control device is automatically displayed on a display of the welding wire feeder. In step 540 of the method 500, a present setting of the output control device is communicated from the welding wire feeder to the welding power source. In step 550 of the method 500, a welding output potential, corresponding to the welding output voltage value, is provided by the welding power source to the welding wire feeder over a welding output cable connecting the welding power source to the welding wire feeder.

In accordance with one embodiment of the present invention, communication between the welding power source 130 and the welding wire feeder 120 is accomplished wirelessly in accordance with, for example, the embodiment of FIG. 3. In accordance with another embodiment of the present invention, communication between the welding power source 130 and the welding wire feeder 120 is accomplished over the welding output cable 310 in accordance with, for example, the embodiment of FIG. 4.

As an example of the method 500, referring to FIG. 2, the welding power source 130 may communicate a welding power source ID to the welding wire feeder 120. The welding wire feeder 120 receives and reads the ID and uses the ID to select a calibration curve stored in a computer memory 125 of the welding wire feeder 120. The calibration curve effectively tells the welding wire feeder 120 how to scale, map, or convert the output range of the output control device 123 to a range of welding output voltage values corresponding to a range of welding output potentials provided by the welding power source 130 for welding. For example, the calibration curves may each be in the form of an addressable look-up table.

For example, if the output control device 123 includes a potentiometer having voltages of −5 VDC and +10 VDC applied across the potentiometer when powered by the welding power source 130, the welding wire feeder 120 may scale the range of −5 VDC to +10 VDC to the range of values of +10 VDC to +80 VDC, based upon the calibration curve for the welding power source, which is equivalent to the range of welding output potentials provided by the welding power source 130. Therefore, if the operator turns a dial or knob (or equivalent thereof) of the output control device 123 such that the potentiometer output reads +5 VDC for example, the welding wire feeder 120, applying the calibration curve, may display a welding output voltage value of, for example, +50 VDC.

Furthermore, when the +5 VDC setting of the output control device 123 is communicated to the welding power source 130 as the present setting of the output control device, a controller in the welding power source 130 is configured to regulate the welding output potential to provide a welding output potential of +50 VDC to the welding wire feeder 120 over the welding output cable when welding.

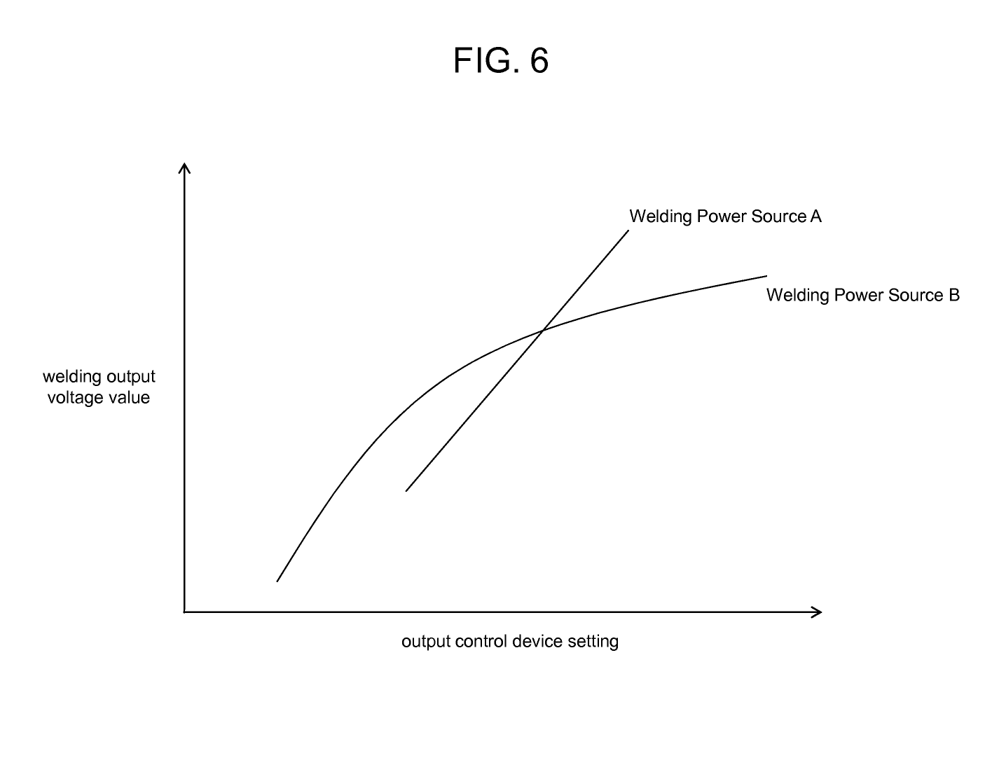

FIG. 6 is a graph illustrating exemplary embodiments of two calibration curves of two welding power sources (welding power source A and welding power source B) being of two different welding power source types. As can be seen from FIG. 6, a calibration curve may be linear (as for welding power source A) or non-linear (as for welding power source B), for example. Again, each welding power source type may have its own calibration curve which can be stored in a welding wire feeder for the purposes discussed herein. In accordance with an alternative embodiment of the present invention, the welding power source 130 may instead communicate its calibration curve to the welding wire feeder 120. In such an alternative embodiment, the welding wire feeder does not have to store a plurality of calibration curves for various types of welding power sources. Instead, the welding power source 130 may store a single calibration curve in its computer memory 135.

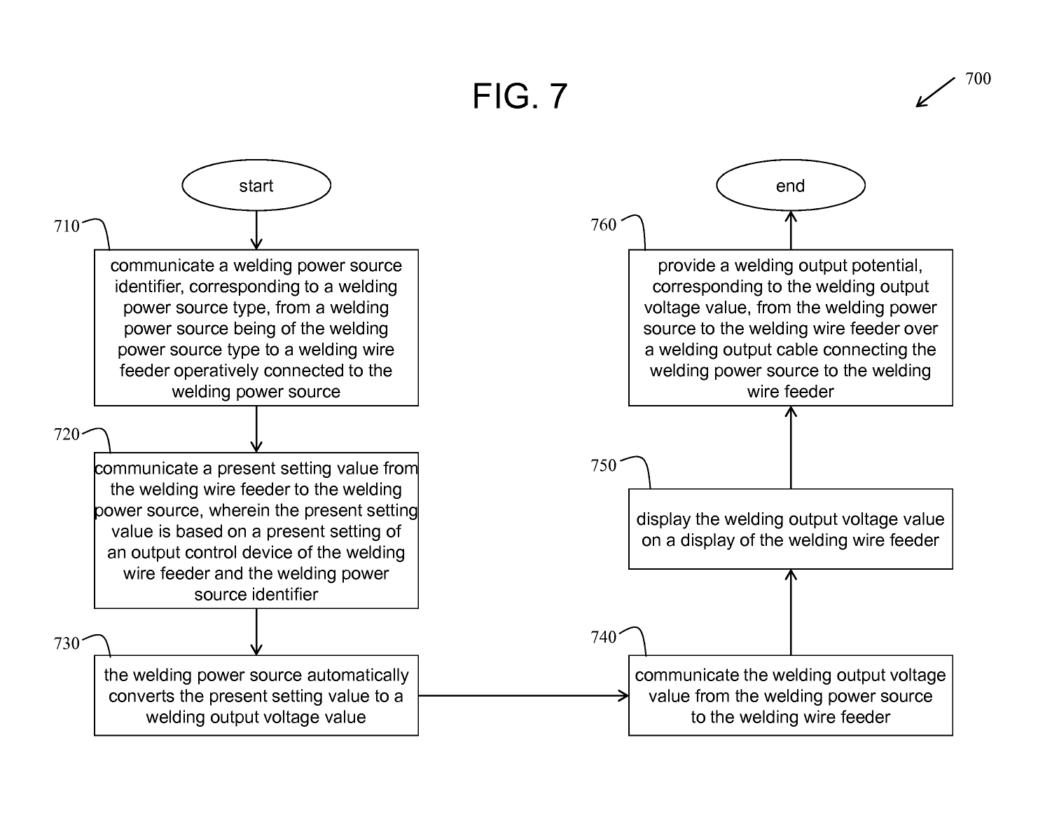

FIG. 7 is a flowchart of a second exemplary embodiment of a method 700 of communication between the welding power source 130 and the welding wire feeder 120 of FIG. 1. In the method 500 of FIG. 5, the calibration curve is in the welding wire feeder 120. In the method 700 of FIG. 7, the calibration curve is in the welding power source 130.

In step 710 of the method 700, a welding power source identifier (ID), corresponding to a welding power source type, is communicated from a welding power source, being of the welding power source type as identified by the ID, to a welding wire feeder operatively connected to the welding power source. In step 720 of the method 700, a present setting value of an output control device of the welding wire feeder is communicated from the welding wire feeder to the welding power source, wherein the present setting value is based on a present setting of an output control device of the welding wire feeder and the welding power source ID. That is, the welding wire feeder is configured to scale or convert the output range of the output control device, based on the welding power source ID, to the range that the welding power source expects to see from the wire feeder.

In step 730 of the method 700, the welding power source automatically converts the present setting value to a welding output voltage value. In accordance with an embodiment, the welding power source employs a calibration curve to accomplish the conversion. In step 740 of the method 700, the welding output voltage value is communicated from the welding power source to the welding wire feeder. In step 750 of the method 700, the welding output voltage value is displayed on a display of the welding wire feeder. In step 760 of the method 700, the welding power source provides a welding output potential, corresponding to the welding output voltage value, to the welding wire feeder over a welding output cable operatively connecting the welding power source to the welding wire feeder. Again, a controller in the welding power source is configured to regulate the welding output potential to provide a welding output potential, based on the present setting value from the wire feeder, to the welding wire feeder over the welding output cable when welding.

In accordance with one embodiment of the present invention, communication between the welding power source 130 and the welding wire feeder 120 is accomplished wirelessly in accordance with, for example, the embodiment of FIG. 3. In accordance with another embodiment of the present invention, communication between the welding power source 130 and the welding wire feeder 120 is accomplished over the welding output cable 310 in accordance with, for example, the embodiment of FIG. 4.

As an example of the method 700, referring again to FIG. 2, the welding power source 130 may communicate a welding power source ID to the welding wire feeder 120. The welding wire feeder 120 receives and reads the ID and uses the ID and the present setting of the output control device 123 to convert an encoder output of the output control device 123 to a present setting value (e.g., 3 VDC). Again, the welding wire feeder 120 is configured to scale or convert the output range of the output control device 123, based on the welding power source ID, to the range (e.g., 0 to 5 VDC) that the welding power source 130 expects to see from the wire feeder 120. The present setting value (e.g., 3 VDC) is then communicated from the welding wire feeder 120 to the welding power source 130 where the welding power source 130, using a calibration curve, converts the present value setting to a welding output voltage value (e.g., 50 VDC).

In general, the welding power source ID tells the welding wire feeder 120 how to convert or scale the encoder output of the output control device 123, and a controller in the welding power source 130 is configured to regulate the welding output potential to provide a welding output potential, based on the present setting value from the wire feeder 120, to the welding wire feeder over the welding output cable 310 when welding. Again, in the method 700 of FIG. 7, the calibration curve is in the welding power source 130. In the method 500 of FIG. 5, the calibration curve is in the welding wire feeder 120. Communication between the welding power source 130 and the welding wire feeder 120 is performed wirelessly (e.g., see FIG. 3) or over the welding output cable 310 (see FIG. 4). No separate control or communication cable is needed between the welding power source 130 and the welding wire feeder 120.

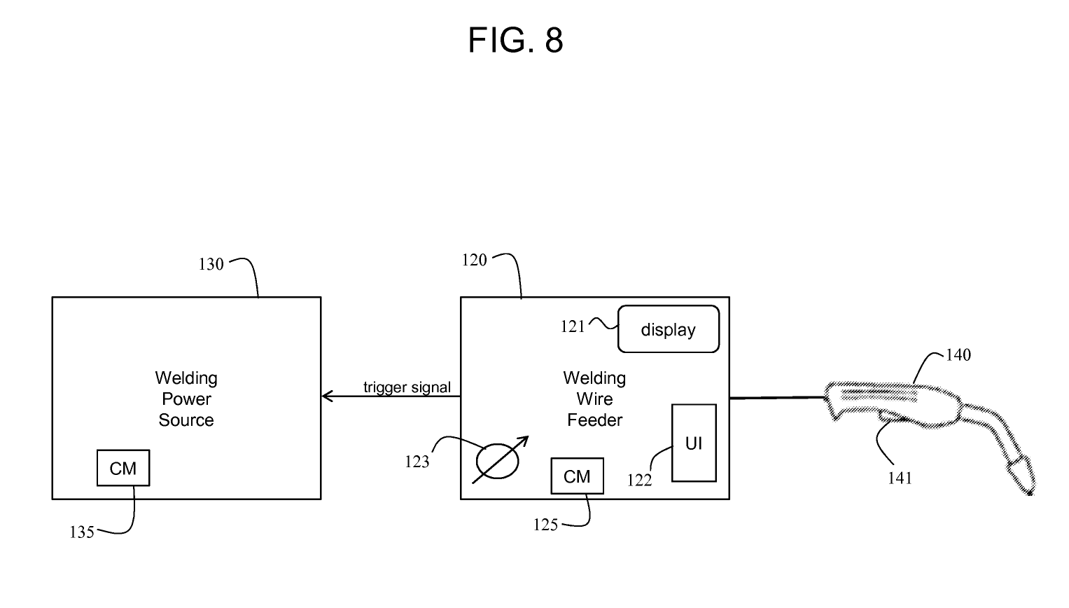

FIG. 8 is a functional block diagram illustrating a second exemplary embodiment of communication between the welding power source 130 and the welding wire feeder 120 of FIG. 1. When an operator of the welding system desires to weld, the operator may press the trigger 141 on the welding tool 140. Upon pressing the trigger 141, a trigger signal is communicated from the welding wire feeder 120 to the welding power source 130, either wirelessly or over the welding output cable as previously described herein with respect to FIGS. 3 and 4.

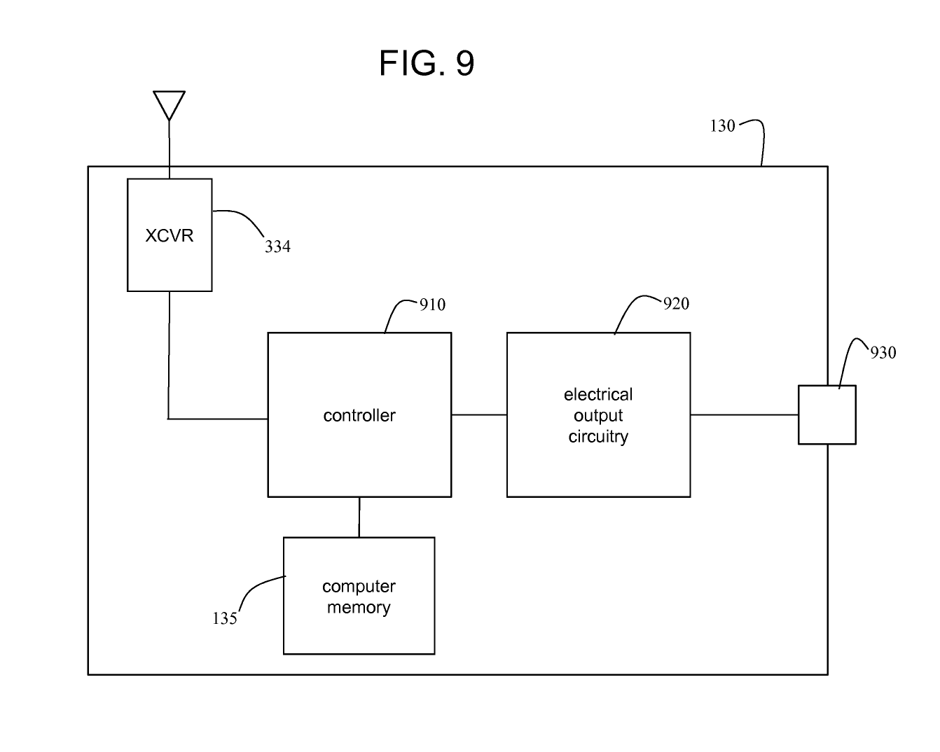

FIG. 9 illustrates a schematic block diagram of an exemplary embodiment of the welding power source 130 of FIG. 8. The welding power source 130 includes a wireless transceiver 334 configured to wirelessly facilitate two-way communication with the welding wire feeder 120. Alternatively, the welding power source 130 may instead include a transceiver 434 configured to facilitate two-way communication with the welding wire feeder 120 over the welding output cable 310 (see FIG. 4). The welding power source 130 also includes a controller 910 operatively connected to the transceiver 334 and electrical output circuitry 920 operatively connected to the controller 910 and providing an electrical output 930. In accordance with an embodiment of the present invention, the electrical output 930 is configured to operatively connect to the welding output cable 310.

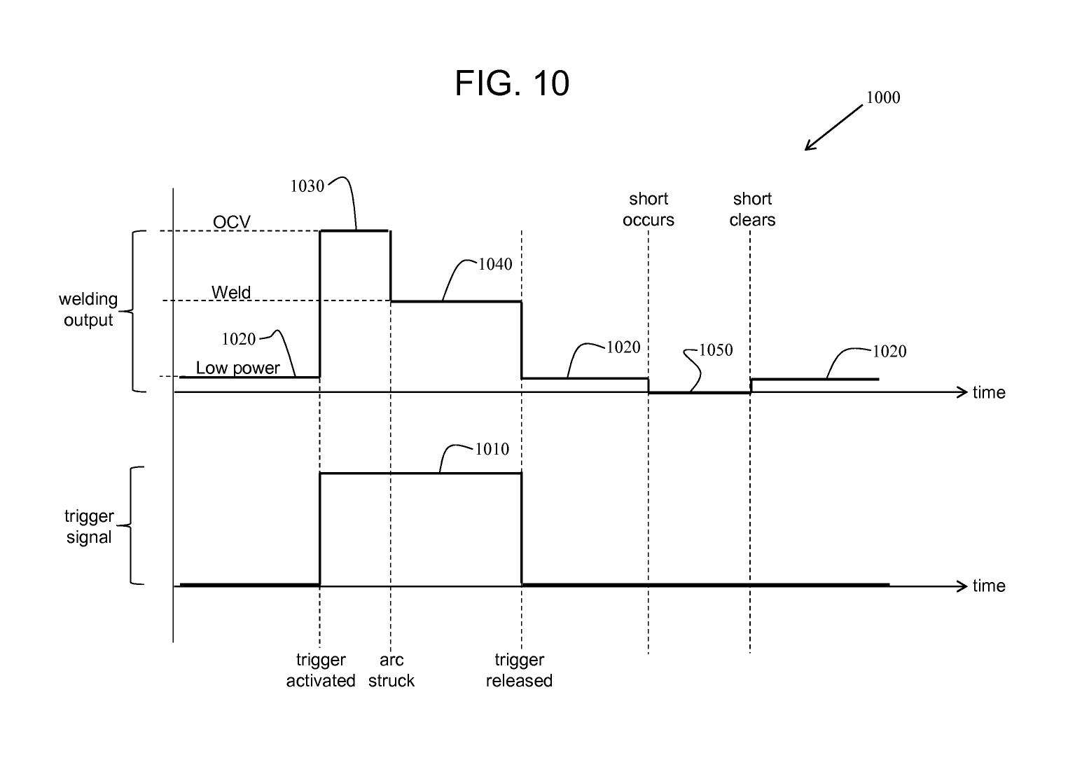

In accordance with an embodiment, the controller 910 and the electrical output circuitry 920 includes a waveform generator, a pulse-width modulator, inverter circuitry and/or chopper circuitry, logic circuitry and/or a processing element and associated software, and computer memory, as is well known in the art. However, the controller 910 and the electrical output circuitry 920 are configured to provide a low power state, in accordance with an embodiment, as described with respect to FIG. 10.

FIG. 10 is an exemplary embodiment of a timing diagram 1000 illustrating the operation of the welding power source 130 of FIG. 9. The timing diagram 1000 shows the welding output in relation to the trigger signal 1010. Before the trigger 141 of the welding tool 140 is activated and the trigger signal 1010 is received at the welding power source 130, the welding power source 130 is in a low power state, where the electrical output is regulated to a low output voltage level 1020 (e.g., 15 VDC). In the low power state, the welding power source 130 is able to provide sufficient electrical power (e.g., 15 VDC at 4 amps) to power the entire welding wire feeder 120, in accordance with an embodiment.

When the trigger 141 is activated and the trigger signal 1010 is received by the power source 130, but before the consumable electrode is positioned proximate a workpiece to strike an arc, the welding power source 130 is in an open circuit voltage (OCV) state, where the electrical output is regulated to an open circuit voltage (OCV) level 1030 (e.g., 80 VDC). A magnitude of the OCV level 1030 is larger than a magnitude of the low output voltage level 1020. In accordance with an embodiment, the OCV level 1030 is sufficient to start an arc between the consumable electrode and the workpiece but the low output voltage level 1020 is not. Furthermore, the OCV level 1030 is further sufficient to power the wire feeder 120.

When an arc is struck between the consumable electrode and the workpiece and the trigger signal 1010 is still present, the welding power source 130 is in a welding state, where the electrical output is regulated to a selected welding output voltage level 1040 (e.g., 50 VDC). A magnitude of the welding output voltage level 1040 is between the magnitudes of the low output voltage level 1020 and the open circuit voltage level 1030. When the trigger 141 of the welding tool 140 is released and the trigger signal 1010 goes away, the welding power source 130 again goes to the low power state, where the electrical output is again regulated to the low output voltage level 1020 (e.g., 15 VDC).

As shown in FIG. 10, if an electrical short occurs between the welding electrode and the workpiece, the welding output goes to a short voltage 1050 of 0 VDC during the time of the short. When the short is cleared, the welding output goes back to the low output voltage level 1020. By providing a low power state, the welding power source can reduce or eliminate an electrical hazard presented to the operator or to the workpiece to be welded by minimizing the presence of the open circuit voltage at the electrical output of the welding power source. By communicating the trigger signal from the wire feeder to the welding power source either wirelessly or over the welding output cable, a separate cable for the trigger signal is not needed. Furthermore, by providing a low power state as described herein, electrical contactors for switching the high power provided by the welding power source may not be needed in the welding wire feeder.

As a safety feature, if the welding power source loses communication with the welding wire feeder (e.g., loses the trigger signal), the welding power source may be configured to automatically return to the low power state. In accordance with an alternative embodiment of the present invention, the trigger signal is complemented by an OFF signal. That is, the welding power source may initially receive a trigger signal to command entry into the OCV state or the welding state, and then receive a separate OFF signal to command return to the low power state.

In summary, systems and methods of communicating between a welding power source and a welding wire feeder to improve the operation of a welding system are disclosed. Two-way communication between a welding power source and a welding wire feeder is provided either wirelessly or over the welding output cable. The communication between the welding power source and the welding wire feeder facilitates output voltage selection at the welding wire feeder as well as the entering of a lower output power state of the welding power source when not welding. Furthermore, the welding power source may provide electrical power to operate the welding wire feeder, eliminating the need for batteries or some other energy storage device in the wire feeder and allowing for robust, two-way communication between the welding power source and the wire feeder, even when the power source and wire feeder are separated by a significant distance.

In appended claims, the terms “including” and “having” are used as the plain language equivalents of the term “comprising”; the term “in which” is equivalent to “wherein.” Moreover, in appended claims, the terms “first,” “second,” “third,” “upper,” “lower,” “bottom,” “top,” etc. are used merely as labels, and are not intended to impose numerical or positional requirements on their objects. Further, the limitations of the appended claims are not written in means-plus-function format and are not intended to be interpreted based on 35 U.S.C. §112, sixth paragraph, unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiments disclosed, but that the claimed subject matter will include all embodiments falling within the scope of the appended claims.

What is claimed is:

1. A method of communication between a welding power source and a welding wire feeder, said method comprising:
communicating a welding power source identifier, corresponding to a welding power source type, from a welding power source being of the welding power source type to a welding wire feeder operatively connected to the welding power source; and
automatically scaling an output range of an output control device of the welding wire feeder, in response to the welding power source identifier, to a range of welding output voltage values corresponding to a range of welding output potentials provided by the welding power source.

2. The method of claim 1, further comprising automatically displaying a welding output voltage value on a display of the welding wire feeder corresponding to a present setting of the output control device.

3. The method of claim 2, further comprising communicating a present setting of the output control device from the welding wire feeder to the welding power source.

4. The method of claim 3, further comprising said welding power source providing a welding output potential, corresponding to said welding output voltage value, to said welding wire feeder over a welding output cable operatively connecting said welding power source to said welding wire feeder.

5. The method of claim 3, wherein said communicating is performed wirelessly.

6. The method of claim 3, wherein said communicating is performed via encoded signals over a welding output cable operatively connecting said welding power source to said welding wire feeder.

7. A method of communication between a welding power source and a welding wire feeder, said method comprising:
communicating a welding power source identifier, corresponding to a welding power source type, from a welding power source being of the welding power source type to a welding wire feeder operatively connected to the welding power source; and
communicating a present setting value from the welding wire feeder to the welding power source, wherein the present setting value is based on a present setting of an output control device of the welding wire feeder and the welding power source identifier.

8. The method of claim 7, further comprising:
said welding power source automatically converting said present setting value to a welding output voltage value; and
communicating said welding output voltage value from said welding power source to said welding wire feeder.

9. The method of claim 8, further comprising displaying said welding output voltage value on a display of said welding wire feeder.

10. The method of claim 8, further comprising said welding power source providing a welding output potential, corresponding to said welding output voltage value, to said welding wire feeder over a welding output cable operatively connecting said welding power source to said welding wire feeder.

11. The method of claim 8, wherein said communicating is performed wirelessly.

12. The method of claim 8, wherein said communicating is performed via encoded signals over a welding output cable operatively connecting said welding power source to said welding wire feeder.

13. A method of controlling an electrical output of a welding power source, said method comprising:
regulating an electrical output of a welding power source to a low output voltage level of a low power state of the welding power source;
regulating the electrical output of the welding power source to an open circuit voltage level when a trigger signal is received at the welding power source from a welding wire feeder, wherein a magnitude of the open circuit voltage level is larger than a magnitude of the low output voltage level; and
regulating the electrical output of the welding power source to a welding output voltage level when an electric arc exists between an electrode and a workpiece electrically connected to the electrical output of the welding power source, wherein a magnitude of the welding output voltage level is between the magnitudes of the low output voltage level and the open circuit voltage level.

14. The method of claim 13, further comprising regulating the electrical output of the welding power source to the low output voltage level of the low power state of the welding power source when the trigger signal is no longer received by the welding power source.

15. The method of claim 13, wherein said trigger signal is wirelessly received by said welding power source from a welding wire feeder.

16. The method of claim 13, wherein said trigger signal is received by said welding power source over a welding output cable operatively connected between the welding power source and a welding wire feeder.

17. A welding system, said welding system comprising:
a welding power source having a first wireless transceiver;
a welding wire feeder having a second wireless transceiver, wherein said first wireless transceiver and said second wireless transceiver are configured to provide two-way communication between said welding power source and said welding wire feeder; and
a welding output cable operatively connecting said welding power source to said welding wire feeder for providing electrical power from said welding power source to said welding wire feeder, wherein said second wireless transceiver is configured to be powered by electrical power from said welding power source.

18. The welding system of claim 17, further comprising a plurality of calibration curves stored in a computer memory of said welding wire feeder, wherein each calibration curve of said plurality of calibration curves corresponds to a welding power source type and is configured to scale an output range of an output control device of the welding wire feeder to a range of welding output voltage values in response to the second wireless transceiver receiving a welding power source identifier, corresponding to a welding power source type, from the first wireless transceiver.

19. The welding system of claim 18, wherein said range of welding output voltage values corresponds to a range of welding output potentials that a welding power source of the corresponding welding power source type is configured to provide to the welding wire feeder over the welding output cable.

20. The welding system of claim 17, wherein said welding wire feeder is configured to be fully powered by electrical power from said welding power source.

21. A welding system, said welding system comprising:
a welding power source having a first transceiver;
a welding wire feeder having a second transceiver; and
a welding output cable operatively connecting said welding power source to said welding wire feeder for providing electrical power from said welding power source to said welding wire feeder, wherein said second transceiver is configured to be powered by electrical power from said welding power source, and wherein said first transceiver and said second transceiver are configured to provide two-way communication between said welding power source and said welding wire feeder over said welding output cable.

22. The welding system of claim 21, further comprising a plurality of calibration curves stored in a computer memory of said welding wire feeder, wherein each calibration curve of said plurality of calibration curves corresponds to a welding power source type and is configured to scale an output range of an output control device of the welding wire feeder to a range of welding output voltage values in response to the second transceiver receiving a welding power source identifier, corresponding to a welding power source type, from the first transceiver.

23. The welding system of claim 22, wherein said range of welding output voltage values corresponds to a range of welding output potentials that a welding power source of the corresponding welding power source type is configured to provide to the welding wire feeder over the welding output cable.

24. The welding system of claim 21, wherein said welding wire feeder is configured to be fully powered by electrical power from said welding power source.

25. A welding power source providing a low power state, said welding power source comprising:
a transceiver configured to facilitate two-way communication with a welding wire feeder;
electrical output circuitry providing an electrical output; and
a controller configured to control the electrical output circuitry by:
regulating the electrical output to a low output voltage level of a low power state of the welding power source when a trigger signal is not being received by the transceiver,
regulating the electrical output to an open circuit voltage level when a trigger signal from a welding wire feeder is being received by the transceiver and when an electric arc does not exist between an electrode and a workpiece electrically connected to the electrical output circuitry, wherein a magnitude of the open circuit voltage level is larger than a magnitude of the low output voltage level, and
regulating the electrical output to a welding output voltage level when a trigger signal from a welding wire feeder is being received by the transceiver and when an electric arc exists between an electrode and a workpiece electrically connected to the electrical output circuitry, wherein a magnitude of the welding output voltage level is between the magnitudes of the low output voltage level and the open circuit voltage level.

26. The welding power source of claim 25 wherein the transceiver is a wireless transceiver.

27. The welding power source of claim 25, wherein the transceiver is configured to communicate with a welding wire feeder over a welding output cable operatively connected between the welding power source and the welding wire feeder.

28. The welding power source of claim 25, wherein said low power state is configured to provide electrical power to fully power a welding wire feeder operatively connected to said welding power source.

29. A welding power source configured to output a low power level when not welding, and further configured to not produce an open circuit voltage or a welding output voltage until receiving a trigger signal.
